(19) United States
(12) Patent Application Publication
(10) Pub. No.: US 2026/0183715 A1
(43) Pub. Date: Jul. 2, 2026

(54) PROCESS SYSTEM FOR SURFACE TREATMENT, RECYCLING EQUIPMENT FOR WASTE LIQUID AND METHOD FOR RECYCLING WASTE LIQUID

(71) Applicant: INDUSTRIAL TECHNOLOGY RESEARCH INSTITUTE, Hsinchu (TW)

(72) Inventors: Sheng-Chih Huang, Tainan City (TW); Guan-You Lin, Hsinchu County (TW)

(73) Assignee: INDUSTRIAL TECHNOLOGY RESEARCH INSTITUTE, Hsinchu (TW)

(21) Appl. No.: 19/232,202

(22) Filed: Jun. 9, 2025

(30) Foreign Application Priority Data
Dec. 31, 2024 (TW) 113151805

(51) Int. Cl. B01D 61/46; C01B 7/07; C01B 17/90

(52) U.S. Cl. CPC B01D 61/463; C01B 7/0706; C01B 17/904

(57) ABSTRACT

A process system for surface treatment, recycling equipment for waste liquid and method for recycling waste liquid is related to a recycling equipment for waste liquid including electrodialysis reactor, cation exchange membranes and at least one anion exchange membrane. The cation exchange membranes and the anion exchange membrane are alternately arranged with intervals in the electrodialysis reactor, to separate the electrodialysis reactor into two electrode chambers, at least one first middle compartment and at least one second middle compartment. Each first middle compartment can receive anion-containing waste liquid and regenerate the anion-containing waste liquid into a chemical agent. Each second middle compartment can receive anions from the anion-containing waste liquid via the anion exchange membrane, receive cations from the anion-containing waste liquid or electrolyte via the cation exchange membrane, and synthesize acid liquid with the anions and the cations.

### CROSS-REFERENCE TO RELATED APPLICATION

This non-provisional application claims priority under 35 U.S.C. § 119(a) to Patent Application No. 113151805 filed in Taiwan, R.O.C. on Dec. 31, 2024, the entire contents of which are hereby incorporated by reference.

### TECHNICAL FIELD

The present disclosure relates to a process technology for performing surface modification on a substrate, and in particular, to a process system for surface treatment, a recycling equipment for waste liquid and a method for recycling waste liquid.

### BACKGROUND

An aluminum foil etching process usually has a plurality of treatment procedures, such as alkali wash, acid wash, electro-etching, coating treatment and chemical cleaning. These treatment procedures require use of lots of acid liquid and alkali liquid. The chemical agent in the coating treatment procedure is usually contaminated by the chemical agent in the electro-etching procedure attached to the surface of the aluminum foil to contain trace amounts of anions, resulting in a gradual decrease in the effectiveness of the coating treatment procedure. Moreover, when the anions in the chemical agent accumulate to a specific concentration, it is required to replace the chemical agent in the coating treatment procedure, and large amounts of anion-containing acid waste liquid will be discharged into the sewage treatment system. The anion-containing acid waste liquid needs to be treated with a large amount of alkali liquid to adjust their pH to neutral, so the sludge and chemical agent costs produced by the entire aluminum foil etching process may increase the overall cost of the aluminum foil etching process. Therefore, some process manufacturers will recycle and regenerate the acid waste liquid through a recycling process.

Common methods for recycling or regenerating acid waste liquid include an ion exchange resin method, a precipitation method, a distillation method and the like, which remove impurities contained in the acid waste liquid and then regenerate a treatment chemical agent to be reintroduced to the process of producing the acid waste liquid.

### SUMMARY

However, common methods for recycling or regenerating acid waste liquid have the problems of high water consumption, high chemical agent usage, high energy consumption and the like. In view of this, a process system for surface treatment, a recycling equipment for waste liquid and a method for recycling waste liquid are provided to solve the above problems, so as to provide a technology for recycling or regenerating anion-containing waste liquid with low energy consumption and low waste discharge, thereby effectively reducing carbon emissions and operating costs of the surface treatment process.

In some examples, a process system for surface treatment is applied to a substrate and includes a coating treatment equipment and a recycling equipment for waste liquid. The coating treatment equipment is configured to perform surface modification on the substrate and includes an acid wash unit, a formation unit and a feeding unit. The acid wash unit is configured to receive acid liquid. The formation unit is configured to receive a chemical agent and output anion-containing waste liquid. The feeding unit is configured to convey the substrate to enable the substrate to sequentially pass through the acid wash unit and the formation unit. The recycling equipment for waste liquid is connected with the coating treatment equipment and includes an electrodialysis reactor, a plurality of cation exchange membranes and at least one anion exchange membrane. The cation exchange membranes and the anion exchange membrane are alternately arranged with intervals in the electrodialysis reactor, to separate the electrodialysis reactor into two electrode chambers, at least one first middle compartment and at least one second middle compartment. The first middle compartment and the at least one second middle compartment are alternately located between the two electrode chambers. Each first middle compartment is configured to regenerate the anion-containing waste liquid into the chemical agent. Each second middle compartment is configured to receive anions from the anion-containing waste liquid via the anion exchange membrane, receive cations from the anion-containing waste liquid or an electrolyte via the cation exchange membrane, and synthesize the acid liquid with the anions and the cations.

In some examples, the formation unit is a coating treatment tank.

In some examples, the acid wash unit is an acid wash tank suitable for containing the acid liquid.

In some examples, the acid liquid is hydrochloric acid or sulfuric acid.

In some examples, the anion-containing waste liquid includes the chemical agent containing phosphate and the anions.

In some examples, the recycling equipment for waste liquid further includes: a temporary storage tank. The temporary storage tank is coupled between the formation unit and the recycling equipment for waste liquid and configured to temporarily store the anion-containing waste liquid.

In some examples, a concentration of the anions of the anion-containing waste liquid outputted by the formation unit is less than a concentration of the anions of the anion-containing waste liquid received by the first middle compartment.

In some examples, the coating treatment equipment further includes: a dispensing tank. The dispensing tank is coupled between the formation unit and the recycling equipment for waste liquid and configured to provide the chemical agent to the acid wash unit. The recycling equipment for waste liquid is configured to provide the chemical agent regenerated in each first middle compartment to the dispensing tank.

In some examples, the recycling equipment for waste liquid is further coupled to the acid wash unit and configured to provide the acid liquid synthesized in each second middle compartment to the acid wash unit.

In some examples, the cation exchange membrane is a hydrogen ion selective membrane.

In some examples, a recycling equipment for waste liquid includes an electrodialysis reactor, a plurality of cation exchange membranes and at least one anion exchange membrane. The cation exchange membranes and the anion exchange membrane are alternately arranged with intervals in the electrodialysis reactor, to separate the electrodialysis reactor into two electrode chambers, at least one first middle compartment and at least one second middle compartment. The at least one first middle compartment and the at least one second middle compartment are alternately located between the two electrode chambers. Each first middle compartment is configured to receive anion-containing waste liquid and regenerate the anion-containing waste liquid into a chemical agent. Each second middle compartment is configured to receive anions from the anion-containing waste liquid via the anion exchange membrane, receive cations from the anion-containing waste liquid or an electrolyte via the cation exchange membrane, and synthesize acid liquid with the anions and the cations.

In some examples, a method for recycling waste liquid includes: injecting anion-containing waste liquid into at least one first middle compartment of an electrodialysis reactor, injecting a first electrolyte into at least one second middle compartment of the electrodialysis reactor, injecting a second electrolyte into two electrode chambers of the electrodialysis reactor, and applying a voltage to two electrodes in the two electrode chambers to perform an electrodialysis procedure. The two electrode chambers, the at least one first middle compartment and the at least one second middle compartment are separated by alternately arranging a plurality of cation exchange membranes and at least one anion exchange membrane in the electrodialysis reactor, and the at least one first middle compartment and the at least one second middle compartment are alternately located between the two electrode chambers. The electrodialysis procedure includes the following steps: electrolyzing the anion-containing waste liquid and the second electrolyte to form anions, cations and a chemical agent in the first middle compartment and form the cations in the electrode chamber, introducing the anions into the second middle compartment via the anion exchange membrane, introducing the cations into the second middle compartment via the cation exchange membrane, and synthesizing acid liquid with the anions and the cations in the second middle compartment.

In some examples, a concentration of the anion-containing waste liquid is less than or equal to 10%.

In some examples, a concentration of the acid liquid in the second middle compartment is less than or equal to 0.5%.

Based on the above, the process system for surface treatment, the recycling equipment for waste liquid or the method for recycling waste liquid according to any example uses the electrodialysis technology in the waste liquid recycling process to remove the anions contained in the anion-containing waste liquid to regenerate the chemical agent and output the acid liquid synchronously. Therefore, there is no need to add additional agents or consume additional heat energy in the waste liquid recycling process, so that the carbon emissions and operating costs of the surface treatment process can be effectively reduced. In some examples, the process system for surface treatment, the recycling equipment for waste liquid or the method for recycling waste liquid can also reintroduce the chemical agent and the acid liquid generated synchronously to the coating treatment equipment for reuse in the surface treatment process, thereby achieving complete recycling and reuse.

### BRIEF DESCRIPTION OF THE DRAWINGS

FIG. 1 is a schematic diagram of a process system for surface treatment according to an example.

FIG. 2 is a schematic diagram of an exemplary example of a main body of a recycling equipment for waste liquid of FIG. 1.

FIG. 3 is a schematic diagram of another exemplary example of the main body of the recycling equipment for waste liquid of FIG. 1.

FIG. 4 is a flowchart of a method for recycling waste liquid according to an example.

FIG. 5 is a flowchart of an exemplary example of step S04 of FIG. 4.

FIG. 6 is a change curve graph of conductivity versus chloride ions concentration of related liquid when a process system for surface treatment is used according to an example.

### DETAILED DESCRIPTION

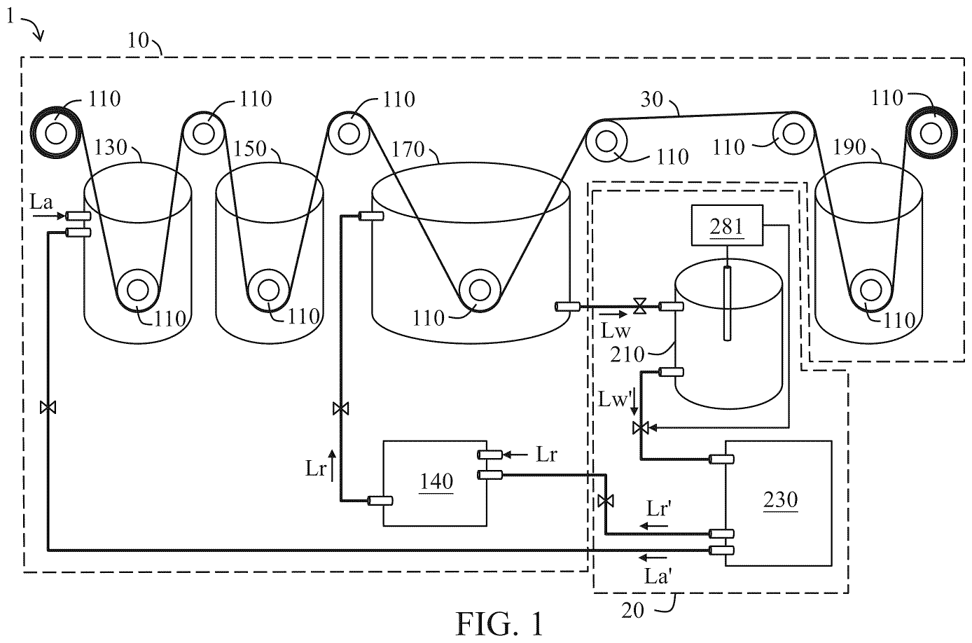

Referring to FIG. 1, a process system for surface treatment 1 includes a coating treatment equipment 10 and a recycling equipment for waste liquid 20. The coating treatment equipment 10 is suitable for performing surface modification on a substrate 30. In some examples, the substrate 30 may be an aluminum foil. For example, the coating treatment equipment 10 may form an aluminum oxide coating on a surface of an aluminum foil to serve as an insulating protective layer for the aluminum foil. The recycling equipment for waste liquid 20 is suitable for performing a recycling procedure on anion-containing waste liquid Lw generated by the coating treatment equipment 10 to generate a chemical agent Lr′ and acid liquid La′ that are reusable.

The coating treatment equipment 10 includes a feeding unit 110 and a plurality of treatment units respectively for performing a plurality of treatment procedures on the substrate 30. The feeding unit 110 defines a feeding path that sequentially passes through the treatment units. The feeding unit 110 is configured to convey the substrate 30 to enable the substrate 30 to sequentially pass through the treatment units. In some examples, these treatment procedures may be more of one or more alkali washes, one or more acid washes, one or more electro-etchings, one or more formations (also known as coating treatment), one or more chemical cleanings, one or more water washes and drying. That is, each treatment unit performs one treatment procedure on the substrate 30. Specifically, the treatment unit may be a treatment tank containing a corresponding treatment solution (e.g., a water bath, a reaction bath, a reaction tank or a rinsing tank). When the substrate 30 passes through any treatment tank, the substrate 30 is soaked in the corresponding treatment solution, so that the treatment solution chemically reacts with a surface of the substrate 30 or cleans the surface of the substrate 30, thus completing the corresponding treatment procedure.

Here, these treatment units at least include an acid wash unit 130 and a formation unit 170. The feeding unit 110 defines a feeding path that sequentially passes through the acid wash unit 130 and the formation unit 170, and is configured to convey the substrate 30 along the feeding path to enable the substrate 30 to sequentially pass through the acid wash unit 130 and the formation unit 170. The acid wash unit 130 is configured to receive acid liquid La and perform acid treatment on the substrate 30 accordingly. The formation unit 170 is configured to receive a chemical agent Lr and perform coating treatment on the substrate 30 accordingly. Here, the formation unit 170 also outputs the used chemical agent Lr (i.e., the anion-containing waste liquid Lw) to the recycling equipment for waste liquid 20. In some examples, the acid wash unit 130 is an acid wash tank suitable for containing the acid liquid La, and the formation unit 170 is a coating treatment tank suitable for containing the chemical agent Lr. Specifically, when the substrate 30 passes through the coating treatment tank (i.e., passes through the formation unit 170), the substrate 30 is soaked in the chemical agent Lr such that the chemical agent Lr chemically reacts with the surface of the substrate 30 to form an insulating protective film on the surface of the substrate 30. The insulating protective film may be aluminum oxide (Al₂O₃).

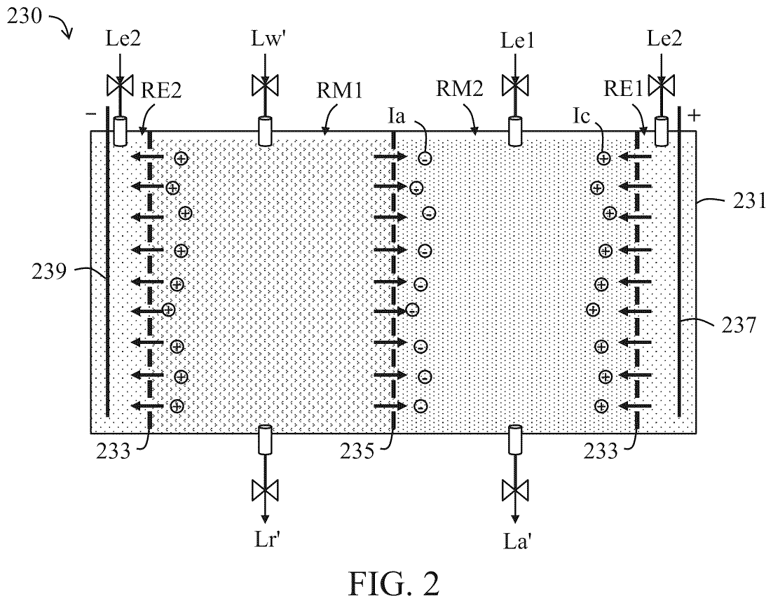

Referring to FIG. 1 and FIG. 2, the recycling equipment for waste liquid 20 uses an electrodialysis technology to remove anions Ia contained in anion-containing waste liquid Lw′ to regenerate the chemical agent Lr′ and output the acid liquid La′ synchronously. Specifically, a main body 230 of the recycling equipment for waste liquid 20 includes an electrodialysis reactor 231, a plurality of cation exchange membranes 233 and at least one anion exchange membrane 235. The cation exchange membranes 233 and the anion exchange membrane 235 are alternately arranged with intervals in the electrodialysis reactor 231, such that the cation exchange membranes 233 and the anion exchange membrane 235 separate an inner space of the electrodialysis reactor 231 into two electrode chambers RE1, RE2 and a plurality of middle compartments RM1, RM2. The middle compartments RM1, RM2 include at least one first middle compartment RM1 and at least one second middle compartment RM2, and the at least one first middle compartment RM1 and the at least one second middle compartment RM2 are alternately located between the two electrode chambers RE1, RE2.

Here, the main body 230 of the recycling equipment for waste liquid 20 further includes two electrodes 237, 239, and the two electrodes 237, 239 are respectively inserted into the two electrode chambers RE1, RE2.

Referring to FIG. 1 to FIG. 4, during a recycling procedure, first, the anion-containing waste liquid Lw′ is injected to the first middle compartment RM1 of the electrodialysis reactor 231 (step S01), a first electrolyte Le1 is injected into the second middle compartment RM2 of the electrodialysis reactor 231 (step S02), and a second electrolyte Le2 is injected into the two electrode chambers RE1, RE2 of the electrodialysis reactor 231 (step S03). After the corresponding solutions are respectively injected into the electrode chambers RE1, RE2, the first middle compartment RM1, and the second middle compartment RM2 (steps S01 to S03), a voltage is applied to the two electrodes 237, 239 in the two electrode chambers RE1, RE2 to perform an electrodialysis procedure (step S04). The anion-containing waste liquid Lw′ is from the formation unit 170.

In some examples, the first electrolyte Le1 may be water or acid liquid with an extremely low concentration. The acid liquid with an extremely low concentration is, for example, hydrochloric acid, sulfuric acid or phosphoric acid. In some examples, the acid liquid with an extremely low concentration is acid liquid with a concentration of less than or equal to 0.1%.

In some examples, the second electrolyte Le2 may be conductive liquid. The conductive liquid is, for example, sodium sulfate, sodium chloride or the aforementioned anion-containing waste liquid Lw, Lw′.

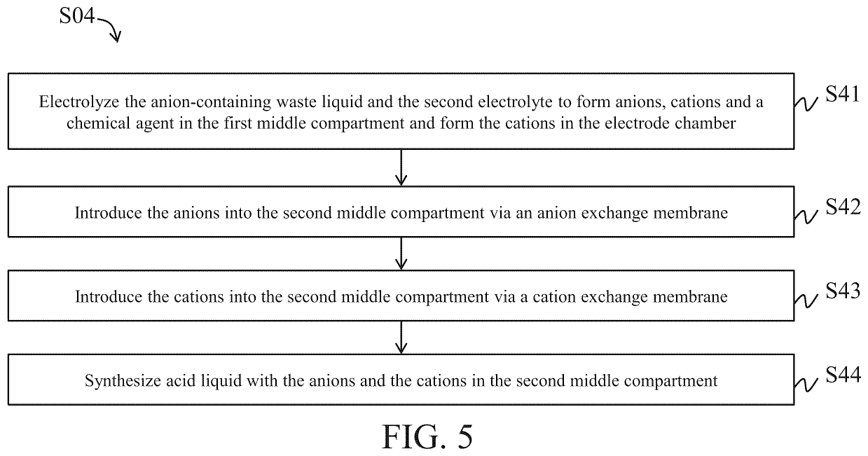

Referring to FIG. 1 to FIG. 5, in step S04, the main body 230 of the recycling equipment for waste liquid 20 electrolyzes the anion-containing waste liquid Lw′ in the first middle compartment RM1 and the second electrolyte Le2 in the electrode chambers RE1, RE2 to form (i.e., separate due to an electric field force) anions Ia, cations Ic and the chemical agent Lr′ in the first middle compartment RM1 and form (i.e., separate due to the electric field force) the cations Ic in the electrode chamber RE1 (step S41). Then, the anions Ia in the middle compartment (i.e., the first middle compartment RM1) adjacent to one side of each second middle compartment RM2 through the anion exchange membrane 235 are introduced into each second middle compartment RM2 via the anion exchange membrane 235 (step S42), and the cations Ic in the electrode chamber RE1 or the middle compartment (i.e., the first middle compartment RM1) adjacent to the other side of each second middle compartment RM2 through the cation exchange membrane 233 are introduced into each second middle compartment RM2 via the cation exchange membrane 233 (step S43). Besides, the main body 230 of the recycling equipment for waste liquid 20 synthesizes the acid liquid La′ with the anions Ia and the cations Ic in each second middle compartment RM2 (step S44). In some examples, the acid liquid La′ is, for example, hydrochloric acid or sulfuric acid. In some examples, the anions Ia are, for example, chloride ions or sulfate ions.

In some examples, the anion-containing waste liquid Lw′ is an acidic water solution containing the anions Ia. Specifically, the anion-containing waste liquid Lw′ includes the chemical agent Lr′ containing phosphate and the anions Ia. In step S41, during the electrolysis, the anions Ia in the anion-containing waste liquid Lw′ become free state. In some examples, the anion-containing waste liquid Lw′ may further include a solvent. The solvent is water. In other words, a concentration of the chemical agent Lr′ containing phosphate is greater than 0% but less than 100%. In step S41, during the electrolysis, in addition to the fact that the anions Ia in the anion-containing waste liquid Lw′ become free state, water in the anion-containing waste liquid Lw′ is decomposed to obtain hydrogen ions (i.e., the cations Ic).

In some examples, the anion-containing waste liquid Lw′ may be waste liquid containing chloride ions. The second electrolyte Le2 includes water. In step S41, during the electrolysis, chloride ions (Cl⁻) (i.e., the anions Ia) and hydrogen ions (H⁺) (i.e., the cations Ic) in free state are generated. In steps S42 to S44, the chloride ions (i.e., the anions Ia) and the hydrogen ions (i.e., the cations Ic) in free state may respectively enter the second middle compartment RM2 via the anion exchange membrane 235 and the cation exchange membrane 233 and form hydrochloric acid (HCl) (i.e., the acid liquid La′) in the second middle compartment RM2.

In some examples, the cation exchange membrane 233 may be a hydrogen ion selective membrane, so as to introduce the hydrogen ions into the second middle compartment RM2 more effectively.

In some examples, the main body 230 of the recycling equipment for waste liquid 20 is further coupled to the acid wash unit 130. Specifically, the second middle compartment RM2 is controllably in communication with the acid wash unit 130. After the electrodialysis procedure (step S04) is completed, the main body 230 of the recycling equipment for waste liquid 20 may provide the acid liquid La′ synthesized in the second middle compartment RM2 to the acid wash unit 130. That is, the acid wash unit 130 receives not only the acid liquid La provided from an external source, but also the acid liquid La′ from the second middle compartment RM2. In some examples, after the electrodialysis procedure (step S04) is completed, the acid liquid La′ in the second middle compartment RM2 is the same as the acid liquid La required by the acid wash unit 130 for the acid wash procedure (for example, both are hydrochloric acid), but has a concentration lower than that of the acid liquid La required for the acid wash procedure. The acid liquid La′ synthesized in the second middle compartment RM2 is mixed with the acid liquid La provided from the external source in the acid wash unit 130 to form the concentration of the acid liquid La required for the acid wash procedure. In some examples, the first electrolyte Le1 may be low-concentration acid liquid which is the same as the acid liquid La′ synthesized in the second middle compartment RM2, i.e., it has a concentration lower than that of the acid liquid La′ in the second middle compartment RM2 after the electrodialysis procedure (step S04) is completed. For example, the acid liquid La′ synthesized in the second middle compartment RM2 after the electrodialysis procedure (step S04) is completed is 0.5% hydrochloric acid, and the first electrolyte Le1 is 0.1% hydrochloric acid.

In some examples, the recycling equipment for waste liquid 20 maintains the concentration of the acid liquid La′ in the second middle compartment RM2 at less than or equal to 0.5%. In other words, when the concentration of the acid liquid La′ in the second middle compartment RM2 is equal to or greater than 0.5%, the recycling equipment for waste liquid 20 discharges the liquid (i.e., the acid liquid La′) in the second middle compartment RM2 and provides the liquid to the acid wash unit 130. Then, during the next electrodialysis procedure, the recycling equipment for waste liquid 20 re-injects the first electrolyte Le1 into the second middle compartment RM2. In some examples, the first electrolyte Le1 may be provided from another external source or prepared (diluted) from the acid liquid La′ generated in the previous electrodialysis procedure. In some examples, the concentration of the acid liquid La′ in the second middle compartment RM2 may be maintained at less than 0.5%.

In some examples, the electrode chamber RE1 is an anode chamber, and the electrode chamber RE2 is a cathode chamber. In some exemplary examples, referring to FIG. 2, in the example where two cation exchange membranes 233 and one anion exchange membrane 235 are alternately arranged with intervals to obtain one first middle compartment RM1 and one second middle compartment RM2, one side of the first middle compartment RM1 is adjacent to the electrode chamber RE2 through the cation exchange membrane 233, and the other side of the first middle compartment RM1 is adjacent to one side of the second middle compartment RM2 through the anion exchange membrane 235. The other side of the second middle compartment RM2 is adjacent to the electrode chamber RE1 through the cation exchange membrane 233. In this case, in steps S42 to S43, the second middle compartment RM2 receives the anions Ia in the first middle compartment RM1 via the anion exchange membrane 235 and receives the cations Ic in the electrode chamber RE1 via the cation exchange membrane 233.

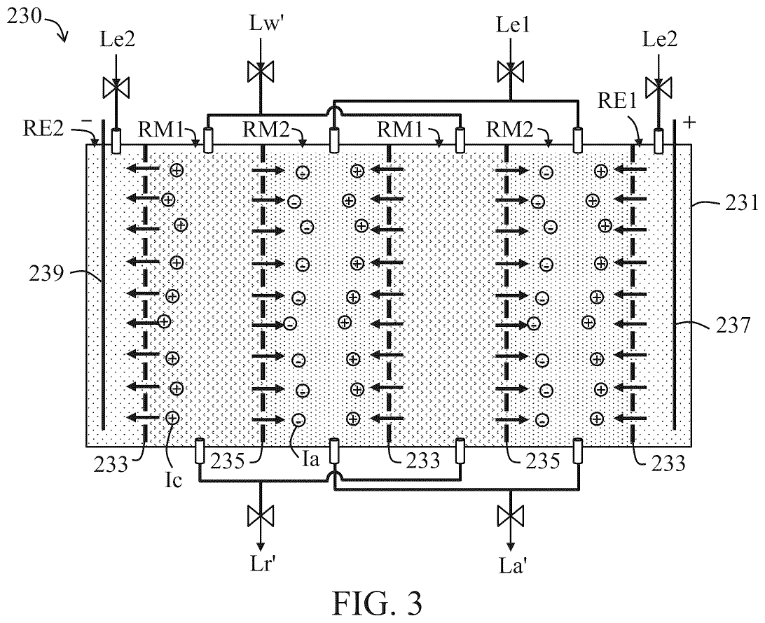

In some other exemplary examples, referring to FIG. 3, in the example where three cation exchange membranes 233 and two anion exchange membranes 235 are alternately arranged with intervals to obtain two first middle compartments RM1 (hereinafter referred to as a left first middle compartment RM1 and a right first middle compartment RM1) and two second middle compartments RM2 (hereinafter referred to as a left second middle compartment RM2 and a right second middle compartment RM2), one side (the left side) of the left first middle compartment RM1 is adjacent to the electrode chamber RE2 through the cation exchange membrane 233, and the other side (the right side) of the left first middle compartment RM1 is adjacent to one side (the left side) of the left second middle compartment RM2 through the anion exchange membrane 235. The other side (the right side) of the left second middle compartment RM2 is adjacent to one side (the left side) of the right first middle compartment RM1 through the cation exchange membrane 233. The other side (the right side) of the right first middle compartment RM1 is adjacent to one side (the left side) of the right second middle compartment RM2 through the anion exchange membrane 235. The other side (the right side) of the right second middle compartment RM2 is adjacent to the electrode chamber RE1 through the cation exchange membrane 233. In this case, in steps S42 to S43, the left second middle compartment RM2 receives the anions Ia from the left first middle compartment RM1 via the anion exchange membrane 235 and receives the cations Ic in the right first middle compartment RM1 via the cation exchange membrane 233, and the right second middle compartment RM2 receives the anions Ia from the right first middle compartment RM1 via the anion exchange membrane 235 and receives the cations Ic in the electrode chamber RE1 via the cation exchange membrane 233.

Therefore, in other examples, the number of the cation exchange membranes 233 and the number of the anion exchange membranes 235 may be adjusted according to needs, so that the number of the middle compartments RM1, RM2 can be adjusted, which is not limited to the aforementioned examples.

In some examples, in step S01, the injected anion-containing waste liquid Lw′ may be directly discharged by the formation unit 170 and injected into the first middle compartment RM1.

In some other examples, in step S01, the injected anion-containing waste liquid Lw′ may also be discharged by the formation unit 170, and then injected into the first middle compartment RM1 after accumulating to a preset concentration. In other words, the recycling equipment for waste liquid 20 may further include a temporary storage tank 210 for temporarily storing the anion-containing waste liquid Lw′. The temporary storage tank 210 is coupled between the formation unit 170 and the first middle compartment RM1 of the main body 230, and is controllably in communication with the formation unit 170 and the first middle compartment RM1. A concentration of the anions of the anion-containing waste liquid Lw outputted by the formation unit 170 is greater than a concentration of the anions in the anion-containing waste liquid Lw′ received by the first middle compartment RM1.

After each coating treatment is completed, the formation unit 170 may first discharge the anion-containing waste liquid Lw′ into the temporary storage tank 210. Only when the anion-containing waste liquid Lw′ in the temporary storage tank 210 accumulates to a preset anion concentration, the anion-containing waste liquid Lw′ in the temporary storage tank 210 is introduced into the first middle compartment RM1. This can prevent a low chloride ions concentration in the anion-containing waste liquid Lw′ from affecting the effectiveness of electrodialysis, and avoid uneven concentration distribution of the chemical agent Lr in the formation unit 170. In some examples, a concentration of the anion-containing waste liquid Lw outputted by the temporary storage tank 210 is less than or equal to 10%.

In some examples, the recycling equipment for waste liquid 20 may use a detection unit 281 to directly measure the anion concentration of the liquid (i.e., the anion-containing waste liquid Lw′) in the temporary storage tank 210. In other words, the detection unit 281 includes an anion meter. For example, when the anions Ia of the anion-containing waste liquid Lw′ are chloride ions, the detection unit 281 includes a chloride ion meter. In some other examples, considering the equipment cost, the recycling equipment for waste liquid 20 may also use the detection unit 281 to measure a conductivity of the liquid (i.e., the anion-containing waste liquid Lw′) in the temporary storage tank 210 to indirectly determine the chloride ions concentration. In other words, the detection unit 281 includes a conductivity meter. When the measured chloride ions concentration or conductivity reaches to a preset value, the detection unit 281 starts a pump or opens a valve such that the anion-containing waste liquid Lw′ in the temporary storage tank 210 is introduced into the first middle compartment RM1.

In some examples, the coating treatment equipment 10 may further include: a dispensing tank 140. The dispensing tank 140 is coupled between the formation unit 170 and the first middle compartment RM1 of the main body 230. The dispensing tank 140 receives not only the chemical agent Lr provided from yet another external source, but also the chemical agent Lr′ regenerated in the first middle compartment RM1. In other words, the coating treatment equipment 10 provides (outputs) the chemical agent Lr′ regenerated in the first middle compartment RM1 to the dispensing tank 140. The dispensing tank 140 adjusts the concentration of the chemical agent Lr′ and provides the chemical agent Lr with a concentration required for coating treatment to the formation unit 170. For example, in an aluminum foil process, the chemical agent Lr may be dipotassium hydrogen phosphate (K₂HPO₄), and the concentration required for coating treatment may be 10%. If the concentration of the chemical agent Lr′ regenerated in the first middle compartment RM1 is less than 10%, then the concentration of the fresh chemical agent Lr inputted to the dispensing tank 140 from the external source is greater than 10%. The regenerated chemical agent Lr′ and the fresh chemical agent Lr are jointly inputted into the dispensing tank 140 for concentration adjustment, so that the dispensing tank 140 can provide 10% dipotassium hydrogen phosphate to the formation unit 170 for coating treatment.

For example, in an aluminum foil process, with the structure illustrated in FIG. 1 and FIG. 3, the substrate 30 is an aluminum foil, the chemical agent Lr is dipotassium hydrogen phosphate, and the anions in the anion-containing waste liquid Lw are chloride ions. Here, the coating treatment equipment 10 has 4 successive treatment units, namely the acid wash unit 130, a first electro-etching unit 150, the formation unit 170 and a second electro-etching unit 190. In other words, the first electro-etching unit 150 is located between the acid wash unit 130 and the formation unit 170 in the order of execution, and the formation unit 170 is located between the first electro-etching unit 150 and the second electro-etching unit 190 in the order of execution. The feeding unit 110 controls the substrate 30 (the aluminum foil) to sequentially pass through the acid wash unit 130, the first electro-etching unit 150, the formation unit 170 and the second electro-etching unit 190 such that the substrate 30 (the aluminum foil) sequentially undergoes an acid wash procedure in hydrochloric acid in the acid wash unit 130, first electro-etching in the first electro-etching unit 150 and coating treatment in the chemical agent Lr (dipotassium hydrogen phosphate) in the formation unit 170 to form an aluminum oxide coating on the surface, and then undergoes second electro-etching in the second electro-etching unit 190. After each aluminum foil process is completed, the waste liquid containing chloride ions in the formation unit 170 is discharged to the temporary storage tank 210. Then, the waste liquid containing chloride ions in the temporary storage tank 210 is introduced into the recycling equipment for waste liquid 20 in batches at two time points for a recycling procedure. Moreover, during the electrodialysis recycling of the recycling equipment for waste liquid 20, changes in the conductivity of the liquid (i.e., the first electrolyte Le1, the acid liquid La′ or a mixture thereof) in the second middle compartment RM2 or the chloride ions removal efficiency of the liquid (i.e., the waste liquid containing chloride ions) in the first middle compartment RM1 are observed.

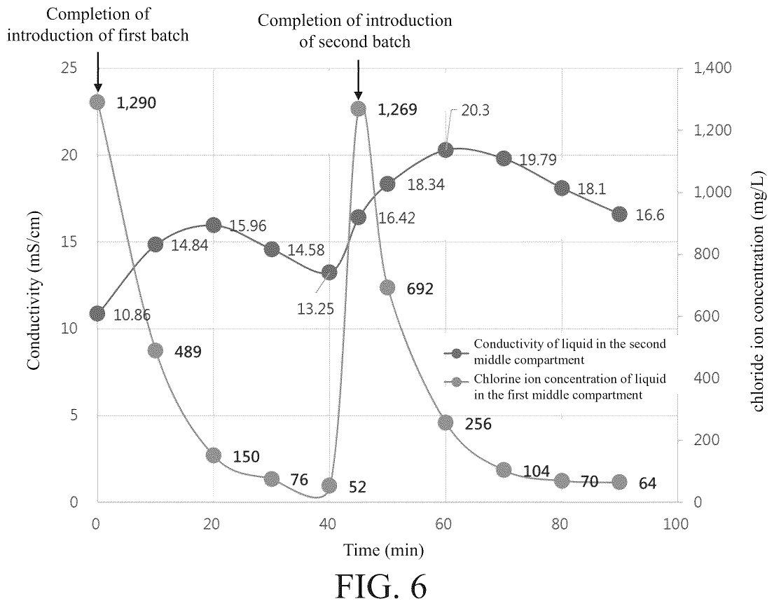

Referring to FIG. 6, when the introduction of the first batch of waste liquid containing chloride ions is completed, the initial conductivity of the liquid in the second middle compartment RM2 is 10.86 mS/cm. After 20 minutes of electrodialysis, the conductivity of the liquid in the second middle compartment RM2 is 15.96 mS/cm, and at this time, the chloride ions removal rate of the waste liquid containing chloride ions in the first middle compartment RM1 reaches 88% (Cl⁻=150 mg/L). After 40 minutes of electrodialysis, the conductivity of the liquid in the second middle compartment RM2 is 13.25 mS/cm, and the chloride ions removal rate of the waste liquid containing chloride ions in the first middle compartment RM1 is 96% (Cl⁻=52 mg/L). When the introduction of the second batch of waste liquid containing chloride ions is completed, the initial conductivity of the liquid in the second middle compartment RM2 is 16.42 mS/cm. After 20 minutes of electrodialysis, the conductivity of the liquid in the second middle compartment RM2 is 20.30 mS/cm, and at this time, the chloride ions removal rate of the waste liquid containing chloride ions in the first middle compartment RM1 reaches 80% (Cl⁻=256 mg/L). After 40 minutes of electrodialysis, the conductivity of the liquid in the second middle compartment RM2 is 16.60 mS/cm, and at this time, the chloride ions removal rate of the waste liquid containing chloride ions in the first middle compartment RM1 is 95% (Cl⁻=64 mg/L). As can be seen, the chloride ions removal rates after introducing the first batch and the second batch of the waste liquid containing chloride ions both reach 90% within 30 minutes (Cl⁻<300 mg/L). The conductivity of the liquid in the second middle compartment RM2 gradually increases (i.e., the concentration of HCl gradually increases) with the accumulation of hydrogen ions and chloride ions. During the 20-minute electrodialysis after the introduction of the waste liquid containing chloride ions, with the decrease in the concentration of the chloride ions in the waste liquid containing chloride ions in the first middle compartment RM1 and the removal of the hydrogen ions in water, the conductivity of the liquid in the first middle compartment RM1 slightly decreases, and the pH increases accordingly.

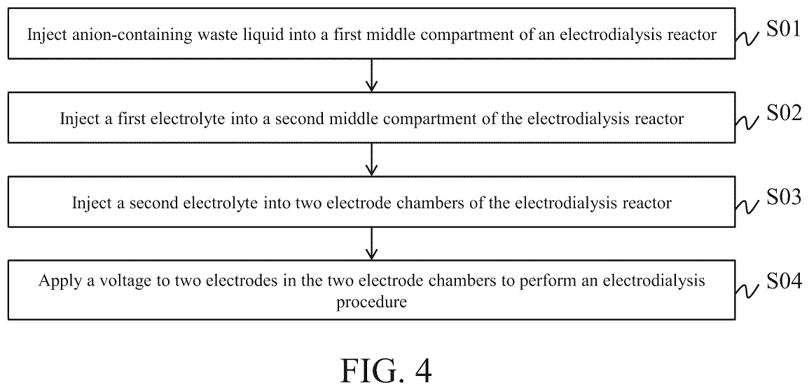

It can be understood that the above steps are described in sequence, but it is not limited thereto. It should be understood that some steps can be carried out at the same time or reversed in sequence under proper circumstances. For example, steps S01 to S03 may be executed sequentially or simultaneously, or executed sequentially in an order of step S01, step S03 and step S02, an order of step S02, step S03 and step S01, an order of step S02, step S01 and step S03, an order of step S03, step S01 and step S02, or an order of step S03, step S02 and step S01. Step S04 is executed only after steps S01 to S03 are completed. In another example, in addition to the sequence illustrated in FIG. 4, steps S42 to S43 may also occur at the same time after step S41 and before step S44 or in a reverse order.

Based on the above, the process system for surface treatment 1, the recycling equipment for waste liquid 20 or the method for recycling waste liquid according to any example uses the electrodialysis technology in the waste liquid recycling process to remove the anions Ia contained in the anion-containing waste liquid Lw′ to regenerate the chemical agent Lr′ and output the acid liquid La′ synchronously. Therefore, there is no need to add additional agents or consume additional heat energy in the waste liquid recycling process, so that the carbon emissions and operating costs of the surface treatment process can be effectively reduced. In some examples, the process system for surface treatment 1, the recycling equipment for waste liquid 20 or the method for recycling waste liquid can also reintroduce the chemical agent Lr′ and the acid liquid La′ generated synchronously to the coating treatment equipment 10 for reuse in the surface treatment process, thereby achieving complete recycling and reuse.

What is claimed is:

1. A process system for surface treatment applied to a substrate, comprising:
a coating treatment equipment, configured to perform surface modification on the substrate and comprising:
an acid wash unit, configured to receive acid liquid;
a formation unit, configured to receive a chemical agent and output anion-containing waste liquid; and
a feeding unit, configured to convey the substrate to enable the substrate to sequentially pass through the acid wash unit and the formation unit; and
a recycling equipment for waste liquid, connected with the coating treatment equipment and comprising:
an electrodialysis reactor;
a plurality of cation exchange membranes, arranged at intervals in the electrodialysis reactor; and
at least one anion exchange membrane, arranged at intervals in the electrodialysis reactor;
wherein the plurality of cation exchange membranes and the at least one anion exchange membrane are alternately arranged, to separate the electrodialysis reactor into two electrode chambers, at least one first middle compartment and at least one second middle compartment, the at least one first middle compartment and the at least one second middle compartment are alternately located between the two electrode chambers, each first middle compartment is configured to regenerate the anion-containing waste liquid into the chemical agent, and each second middle compartment is configured to receive anions from the anion-containing waste liquid via the anion exchange membrane, receive cations from the anion-containing waste liquid or an electrolyte via the cation exchange membrane, and synthesize the acid liquid with the anions and the cations.

2. The process system for surface treatment according to claim 1, wherein the formation unit is a coating treatment tank.

3. The process system for surface treatment according to claim 2, wherein the acid wash unit is an acid wash tank suitable for containing the acid liquid.

4. The process system for surface treatment according to claim 3, wherein the acid liquid is hydrochloric acid or sulfuric acid.

5. The process system for surface treatment according to claim 2, wherein the anion-containing waste liquid comprises the chemical agent containing phosphate and the anions.

6. The process system for surface treatment according to claim 1, wherein the recycling equipment for waste liquid further comprises: a temporary storage tank, coupled between the formation unit and the recycling equipment for waste liquid and configured to temporarily store the anion-containing waste liquid.

7. The process system for surface treatment according to claim 6, wherein a concentration of the anions of the anion-containing waste liquid outputted by the formation unit is less than a concentration of the anions of the anion-containing waste liquid received by the first middle compartment.

8. The process system for surface treatment according to claim 1, wherein the coating treatment equipment further comprises: a dispensing tank, coupled between the formation unit and the recycling equipment for waste liquid and configured to provide the chemical agent to the acid wash unit, wherein the recycling equipment for waste liquid is configured to provide the chemical agent regenerated in each first middle compartment to the dispensing tank.

9. The process system for surface treatment according to claim 1, wherein the recycling equipment for waste liquid is coupled to the acid wash unit and configured to provide the acid liquid synthesized in each second middle compartment to the acid wash unit.

10. The process system for surface treatment according to claim 1, wherein the cation exchange membrane is a hydrogen ion selective membrane.

11. A recycling equipment for waste liquid, comprising:
an electrodialysis reactor;
a plurality of cation exchange membranes, located in the electrodialysis reactor; and
at least one anion exchange membrane, located in the electrodialysis reactor;
wherein the plurality of cation exchange membranes and the at least one anion exchange membrane are alternately arranged with intervals, to separate the electrodialysis reactor into two electrode chambers, at least one first middle compartment and at least one second middle compartment, the at least one first middle compartment and the at least one second middle compartment are alternately located between the two electrode chambers, each first middle compartment is configured to receive anion-containing waste liquid and regenerate the anion-containing waste liquid into a chemical agent, and each second middle compartment is configured to receive anions from the anion-containing waste liquid via the anion exchange membrane, receive cations from the anion-containing waste liquid or an electrolyte via the cation exchange membrane, and synthesize acid liquid with the anions and the cations.

12. A method for recycling waste liquid, comprising:
injecting anion-containing waste liquid into at least one first middle compartment of an electrodialysis reactor;
injecting a first electrolyte into at least one second middle compartment of the electrodialysis reactor;
injecting a second electrolyte into two electrode chambers of the electrodialysis reactor, wherein the two electrode chambers, the at least one first middle compartment and the at least one second middle compartment are separated by alternately arranging a plurality of cation exchange membranes and at least one anion exchange membrane in the electrodialysis reactor, and the at least one first middle compartment and the at least one second middle compartment are alternately located between the two electrode chambers; and
applying a voltage to two electrodes in the two electrode chambers to perform an electrodialysis procedure, wherein the electrodialysis procedure comprises the following steps:
electrolyzing the anion-containing waste liquid and the second electrolyte to form anions, cations and a chemical agent in the first middle compartment and form the cations in the electrode chamber;
introducing the anions into the second middle compartment via the anion exchange membrane;
introducing the cations into the second middle compartment via the cation exchange membrane; and
synthesizing acid liquid with the anions and the cations in the second middle compartment.

13. The method for recycling waste liquid according to claim 12, wherein a concentration of the anion-containing waste liquid is less than or equal to 10%.

14. The method for recycling waste liquid according to claim 12, wherein a concentration of the acid liquid in the second middle compartment is less than or equal to 0.5%.
